(19) United States
(12) Patent Application Publication
(10) Pub. No.: US 2023/0114655 A1
(43) Pub. Date: Apr. 13, 2023

(54) PAPERBOARD BOTTOM BLANK SHAPING APPARATUS AND METHOD FOR SHAPING A PAPERBOARD BOTTOM BLANK

(71) Applicant: WestRock MWV, LLC, Atlanta, GA (US)

(72) Inventors: Brian K. Knapp, West Point, VA (US); Sergio A. Giuste, Midlothian, VA (US); Terrell J. Green, Raleigh, NC (US); Timothy R. McNeal, Richmond, VA (US); Joel C. Panek, Moseley, VA (US); James M. Taylor, Highland Springs, VA (US); Babek Mirzaei, Richmond, VA (US); Jiebin Pang, Glen Allen, VA (US)

(73) Assignee: WestRock MWV, LLC, Atlanta, GA (US)

(21) Appl. No.: 17/910,159

(22) PCT Filed: Mar. 10, 2021
(86) PCT No.: PCT/US2021/021623

§ 371 Date: Sep. 8, 2022

Related U.S. Application Data
(60) Provisional application No. 62/989,134, filed on Mar. 13, 2020.

(51) Int. Cl. B31B 50/59

(52) U.S. Cl. CPC B31B 50/592

(57) ABSTRACT

A cylindrical punch head (2) includes a punch face (3) and a side surface (4). The punch face extends in a radial direction about an axis of the punch head. The side surface extends in an axial direction of the punch head about a periphery of the punch face. The side surface defines a plurality of grooves (6). Each groove extends in the axial direction of the punch head. A method for shaping a paperboard bottom blank to shape a peripheral skirt portion about a periphery of the paperboard bottom blank using the cylindrical punch head.

### PRIORITY

This application claims priority from U.S. Ser. No. 62/989,134 filed on Mar. 13, 2020, the entire contents of which are incorporated herein by reference.

### FIELD

The present application relates to the field of paperboard containers, in particular, paperboard cups and tubs.

### BACKGROUND

Paperboard is used in various packaging applications. For example, paperboard is used to package beverage containers, frozen foods, cereals and a wide variety of other food and non-food consumer goods. Paperboard is often required to have enhanced barrier properties, including oil, grease, water, and/or moisture vapor barrier properties. Additionally, many paperboard packages, for example, paperboard cups for food or drink services, also require the paperboard be heat-sealable, making it possible to form cups on a cup machine. Conventional polyethylene extrusion coated paperboard dominates in such applications by providing both barrier and heat-seal properties.

However, conventional polyethylene extrusion coated paperboard has difficulties in repulping and are not easily recyclable, causing environmental concerns.

Repulpable aqueous coatings are one of the promising solutions to address this need. However, the use of repulpable aqueous coatings has presented challenges with regards to cracking of the coatings when shaping a coated paperboard bottom blank for use in a paperboard container.

Accordingly, those skilled in the art continue with research and development efforts in the field of coated paperboard containers.

### SUMMARY

In one embodiment, there is a cylindrical punch head for shaping a paperboard bottom blank to shape a peripheral skirt portion about a periphery of the paperboard bottom blank. The punch head includes a punch face and a side surface. The punch face extends in a radial direction about an axis of the punch head. The side surface extends in an axial direction of the punch head about a periphery of the punch face. The side surface defines a plurality of grooves. Each groove extends in the axial direction of the punch head.

In another embodiment, there is a method for shaping a paperboard bottom blank. The method includes providing a paperboard bottom blank having a caliper thickness t and shaping the paperboard bottom blank using a cylindrical punch head, thereby shaping a bottom wall having a diameter D_{P} and a peripheral skirt having a skirt height lₛₖ about a periphery of the bottom wall of the paperboard bottom blank. The punch head includes a punch face and a side surface. The punch face extends in a radial direction about an axis of the punch head. The side surface extends in an axial direction of the punch head about a periphery of the punch face. The side surface defines a plurality of grooves. Each groove extends in the axial direction of the punch head.

In yet another embodiment, there is a paperboard bottom blank shaped by the above-described method for shaping a paperboard bottom blank.

In yet another embodiment, there is a paperboard container including the above-identified paperboard bottom blank.

Other embodiments of the disclosed punch head and method for shaping a paperboard bottom blank will become apparent from the following detailed description, the accompanying drawings and the appended claims.

### BRIEF DESCRIPTION OF THE DRAWINGS

FIG. 1 is an image of a paperboard bottom blank showing severe wrinkling.

FIG. 2 is a top view of a punch according to the present description.

FIG. 3 is a bottom view of the punch of FIG. 2.

FIG. 4 is a sectional side view of the punch of FIG. 2 along section line A—A of FIGS. 2 and 3.

FIG. 5 is a perspective view of the punch of FIG. 2.

FIG. 6 is a representation of a side view of a punch to express preferred parameters of the head of the present description.

FIG. 7 is a representation of a top view of a punch to express preferred parameters of the head of the present description.

FIG. 8 is a representation of a side view of a punch to express preferred parameters of the head of the present description.

FIG. 9 is a representation of another top view of a punch to express preferred parameters of the head of the present description.

FIG. 10 is a representation of a side view of a punch to express preferred parameters of the head of the present description.

FIG. 11 is a perspective view of an exemplary paperboard bottom blank capable of use with the punch of the present description.

FIG. 12 is a sectional side view of the exemplary paperboard bottom blank of FIG. 11.

FIGS. 13A, 13B and 13C are schematic views of an exemplary cup bottom forming apparatus for shaping the paperboard bottom blank of FIGS. 11 and 12.

FIG. 14 is a sectional schematic view of a representation of a paperboard container according to an embodiment of the present invention.

FIGS. 15 and 16 are photographs of the cups of Example 1, showing substantial staining about the periphery of the bottom rim.

FIGS. 17 and 18 are photographs of the cups of Example 2, showing decreased staining compared to the cups of Example 1.

FIGS. 19 and 20 are photographs of the cups of Example 3, showing decreased staining compared to the cups of Example 2.

### DETAILED DESCRIPTION

It has now been discovered that cracking of a coating during a shaping process of a paperboard bottom blank can be reduced by controlling a wrinkling of a paperboard bottom blank during the shaping process. Conventional polymer extrusion coatings, such as polyethylene, typically survive the shaping process without cracking even without these modifications. These modifications allow for less-flexible, more brittle, or less strong coatings to survive the shaping process with less cracking.

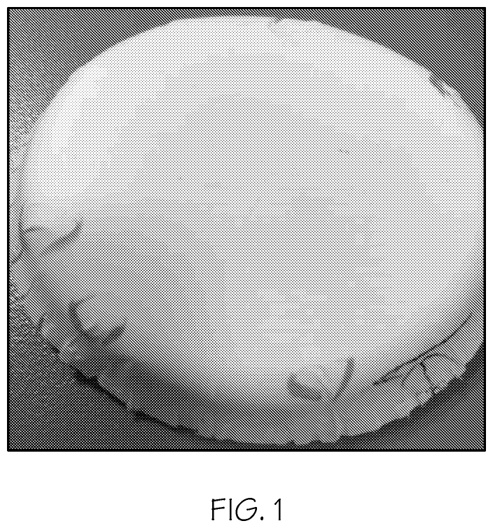

FIG. 1 shows an uncontrolled severe wrinkling of a paperboard bottom blank. As shown by the markings in FIG. 1, numerous wrinkles propagate beyond peripheral skirt of the shaped paperboard bottom blank to the bottom wall of the paperboard bottom blank. These wrinkles disrupt the film formed by some barrier coatings and provide channels and weak points for moisture to penetrate, causing staining or leaking upon use.

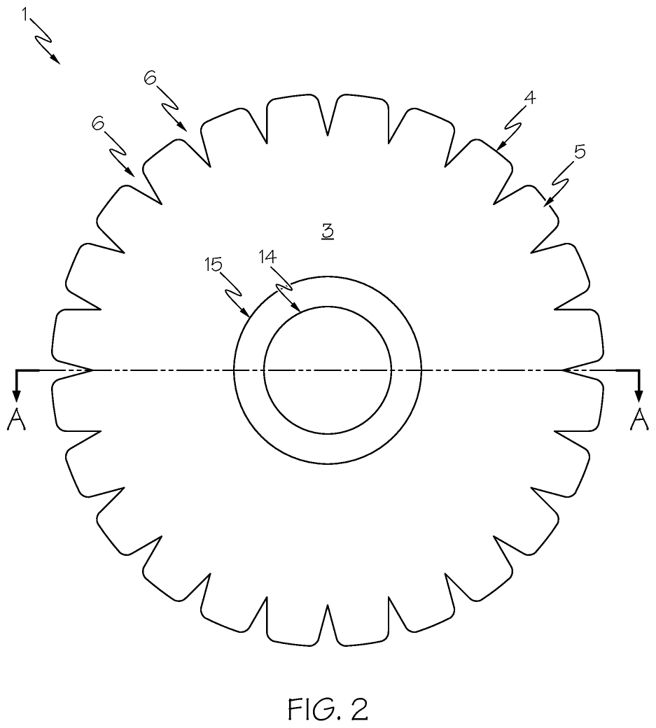

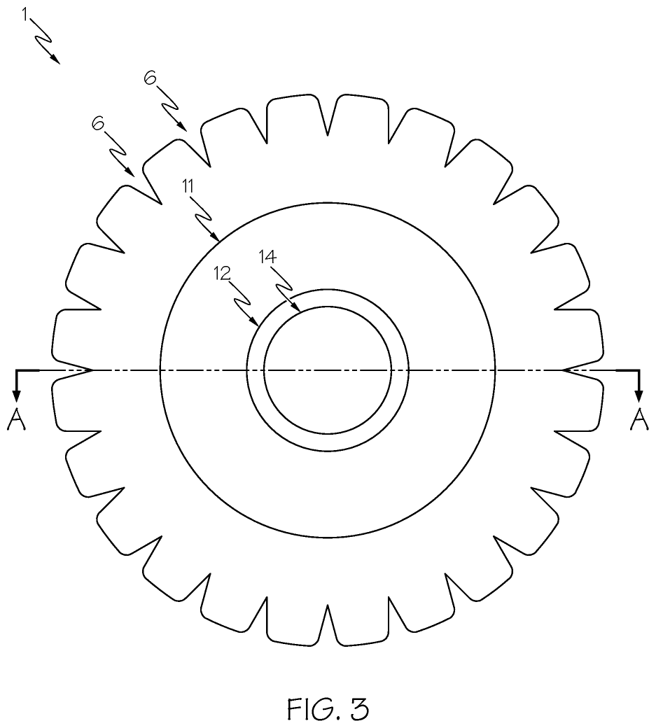

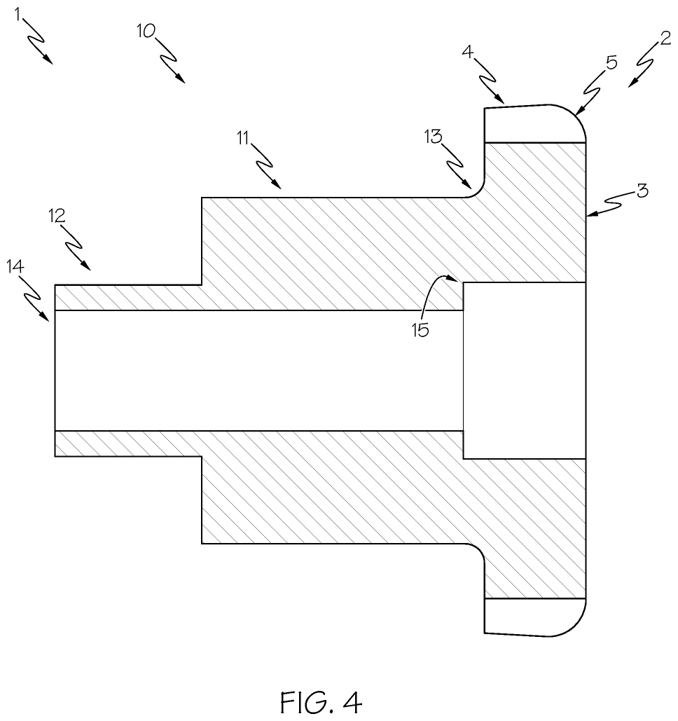

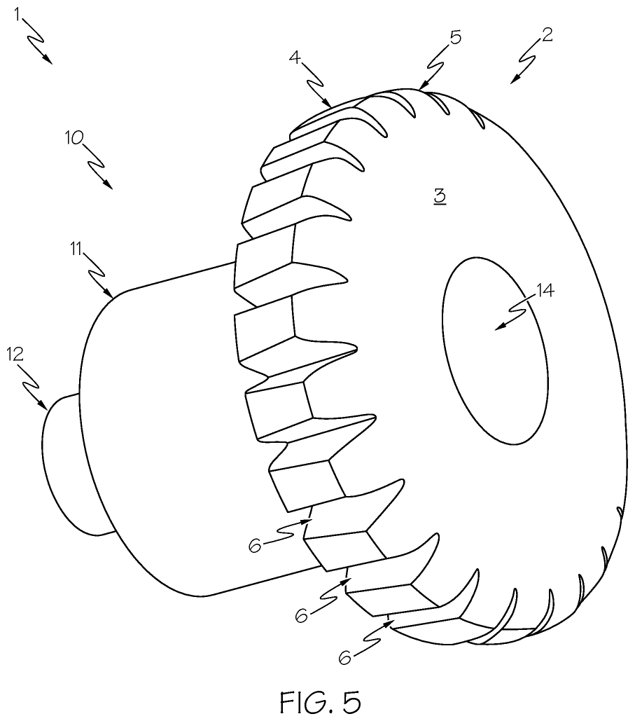

FIGS. 2 to 5 illustrate a punch 1 for shaping a paperboard bottom blank to shape a peripheral skirt portion about a periphery of the paperboard bottom blank according to an exemplary embodiment of the present description.

The punch 1 may include a cylindrical punch head 2 and a punch support 10 supporting the punch head 2. The punch support 10 may include a first punch support portion 11 and a second punch support portion 12. The first punch support portion 11 may have a diameter smaller than a diameter of the punch head 2, and the second punch support portion 12 may have a diameter smaller than a diameter of the first punch support portion 11. The first punch support portion 11 may function to provide direct support to the punch head 2, and the second punch support portion 12 may function to facilitate engagement to a punch apparatus (not shown) for moving the punch head 2 in an axial direction a. The second punch support portion 12 may include a rounded radius 13 for distributing a load between the second punch support portion 12 and the punch head 2. The punch support 10 may further include an axial bore 14 to facilitate engagement to a punch apparatus. The axial bore 14 may extend in the axial direction through the second punch support portion 12 and the first punch support portion 11. The axial bore 14 may include an engagement ledge 15 for to facilitate engagement to a punch apparatus. However, one or more of the above-described features of the punch support 10 may be omitted or the details varied depending on the details of the punch apparatus.

According to the present description, the punch head 2 may include a punch face 3 extending in a radial direction r about the axis a of the punch head 2 and a side surface 4 extending in the axial direction a about a periphery of the punch face 3. The side surface 4 defines a plurality of grooves 6, each groove 6 extending in the axial direction a of the punch head 2. By including the plurality of grooves 6 defined in the side surface 4, the paperboard is provided with guide points for more controlled wrinkle formation and propagation and corresponding alleviation of coating stress.

TABLE 1

| | Orientation | Symbol |
|---|---|---|
| GROOVE | | |
| Groove spacing | Radial | θ^{R}_{G, s} |
| Groove taper | Axial | θ^{A}_{G, t} |
| Groove width (at face | Circumferential | w^{C}_{G} |
| edge) | | |
| Groove length | Axial | l_{G} |
| Groove offset | Axial | l_{G, O} |
| Groove depth | Radial | d_{G} |
| Groove edge radius | Axial | ρ_{G} |
| Groove radial taper | Radial | θ^{R}_{G, t} |
| EDGE | | |
| Edge radius | | ρ_{E} |
| SIDE | | |
| Side height | Axial | l^{A}_{S} |
| Punch diameter (top) | Radial | D_{P} |
| Punch diameter (bottom) | Radial | D_{P, b} |
| Side taper | | D_{P, b}/D_{P} |

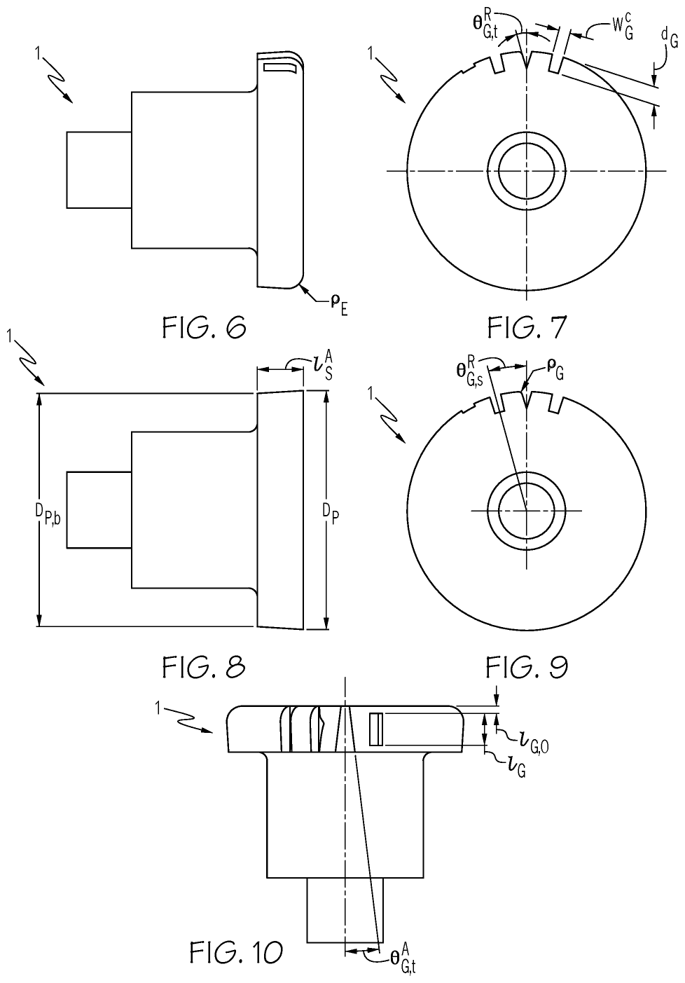

FIGS. 6 to 10 are referenced, in combination with the parameters of Table 1 and with the following explanation, to express preferred parameters of the punch head 2 of the present description configured for use with paperboard having a caliper thickness of between 8 point (0.008 inch.) and 16 point (0.016 inch.), preferably between 10 point (0.010 inch.) and 13 point (0.013 inch.) to shape a paperboard bottom blank having a diameter D_{P} of about 2.3 inch. and a peripheral skirt height l^{a}ₛ of about 0.2 inch to about 0.75 inch.

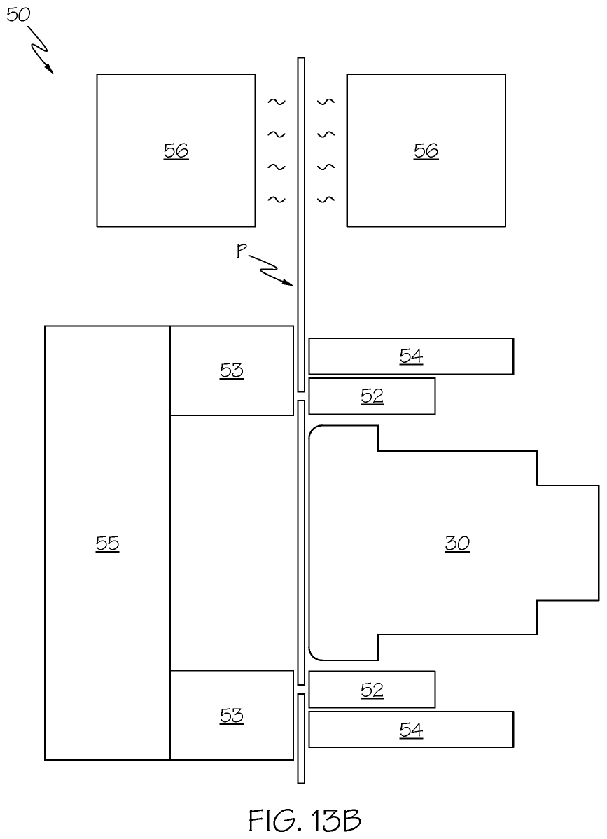

With reference to FIG. 9, a groove spacing θ^{R}_{G,s} between a centerline of adjacent grooves 6 of the plurality of grooves 6 may be controlled. If the groove spacing θ^{R}_{G,s} between a centerline of adjacent grooves 6 of the plurality of grooves 6 is too high, then it may be difficult to control a wrinkling between adjacent grooves 6. If the groove spacing θ^{R}_{G,s} between a centerline of adjacent grooves 6 of the plurality of grooves 6 is too low, then insufficient wrinkling within the grooves 6 may occur. In an aspect, the groove spacing θ^{R}_{G,s} between a centerline of adjacent grooves 6 of the plurality of grooves 6 is between 2 and 90 degrees. In another aspect, the groove spacing θ^{R}_{G,s} between a centerline of adjacent grooves 6 of the plurality of grooves 6 is between 6 and 65 degrees. In yet another aspect, the groove spacing θ^{R}_{G,s} between a centerline of adjacent grooves 6 of the plurality of grooves 6 is between 8 and 53 degrees. In yet another aspect, the groove spacing θ^{R}_{G,s} between a centerline of adjacent grooves 6 of the plurality of grooves 6 is between 11 and 40 degrees. In an exemplary embodiment, the groove spacing θ^{R}_{G,s} between a centerline of adjacent grooves 6 of the plurality of grooves is about 15 degrees.

With reference to FIGS. 2, 3, and 5, a number of grooves 6 along the side surface 4 about the entire periphery of the punch face 3 may be controlled. If the number of grooves along the side surface 4 about the entire periphery of the punch face 3 is too low, then it may be difficult to control a wrinkling between adjacent grooves 6. If the number of grooves along the side surface 4 about the entire periphery of the punch face 3 is too high, then insufficient initiation of wrinkling within the grooves may occur. In an aspect, the number of grooves 6 along the side surface 4 about the entire periphery of the punch face 3 is between 4 and 180. In another aspect, the number of grooves 6 along the side surface 4 about the entire periphery of the punch face 3 is between 10 and 128. In yet another aspect, the number of grooves 6 along the side surface 4 about the entire periphery of the punch face 3 is between 14 and 102. In yet another aspect, the number of grooves 6 along the side surface 4 about the entire periphery of the punch face 3 is between 17 and 76. In an exemplary embodiment, the number of grooves along the side surface 4 about the entire periphery of the punch face 3 is about 24.

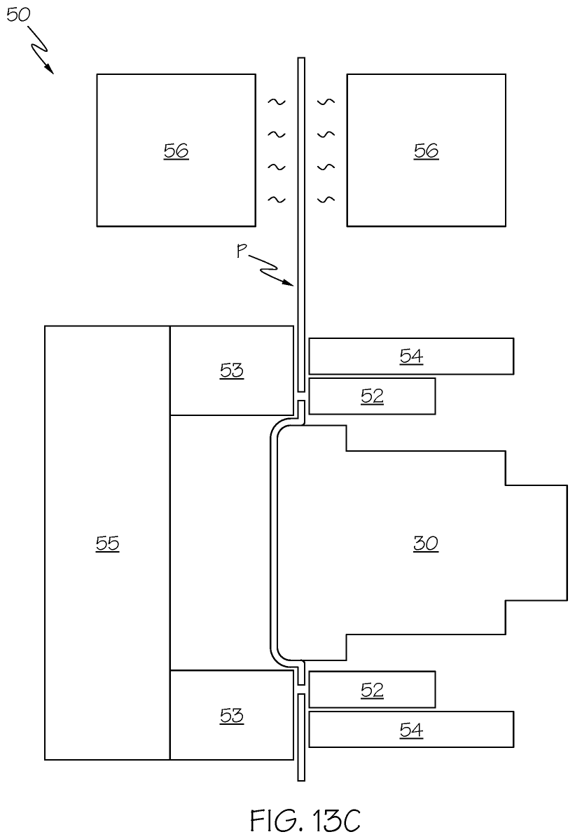

With reference to FIG. 10, a groove taper θ^{A}_{G,t} of the plurality of grooves with respect to the axial direction of the punch head may be controlled. If the groove taper θ^{A}_{G,t} is too low (i.e. too negative), then then it may be difficult to control an initiation position of the wrinkles. If the groove taper θ^{A}_{G,t} is too high (i.e. too positive), then it may be difficult to control an propagation of the wrinkles. In an aspect, the groove taper θ^{A}_{G,t} of the plurality of grooves with respect to the axial direction of the punch head is between −30 and 30 degrees. In an exemplary embodiment, the groove taper θ^{A}_{G,t} of the plurality of grooves with respect to the axial direction of the punch head is approximately zero.

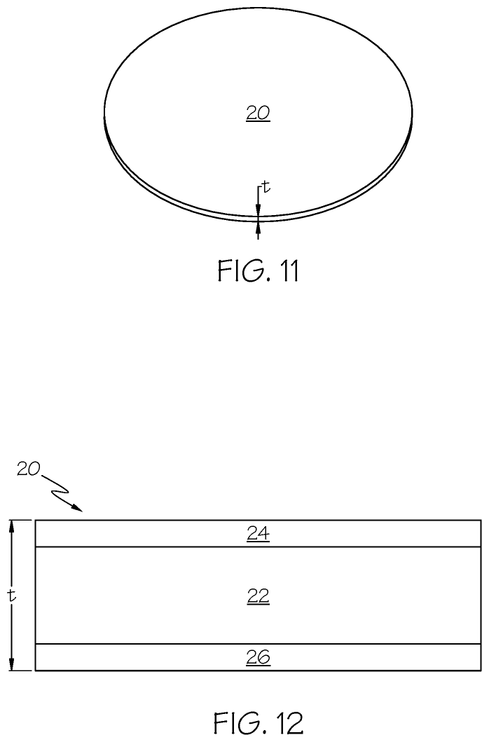

With reference to FIG. 7, a groove width w^{C}_{G}, at the punch face end, of the plurality of grooves may be controlled. If the groove width w^{C}_{G} is too low, then it may be difficult to initiate wrinkling within the grooves. If the groove width w^{C}_{G} is too high, then it may be difficult to control an initiation position of the wrinkles. In an aspect, the groove width w^{C}_{G} of the plurality of grooves is between 0.01 inch. and 0.8 inch. In another aspect, the groove width w^{C}_{G} of the plurality of grooves is between 0.03 inch. and 0.6 inch. In yet another aspect, the groove width w^{C}_{G} of the plurality of grooves is between 0.05 inch. and 0.5 inch. In yet another aspect, the groove width w^{C}_{G} of the plurality of grooves is between 0.07 inch. and 0.3 inch. In an exemplary embodiment, the groove width w^{C}_{G} of the plurality of grooves is about 0.1 inch.

With reference to FIG. 10, a groove length l_{G} of the plurality of grooves may be controlled. If the groove length l_{G} is too low, then it may be difficult to control initiation and propagation of wrinkling. If the groove length l_{G} is too high, then the excess height of the groove may become unnecessary and may cause design constraint problems for the punch head. In an aspect, the groove length l_{G} of the plurality of grooves is between 0.02 inch. and 2 inch. suitable for a peripheral skirt height l^{A}ₛ of about 0.2 inch to about 0.75 inch. In another aspect, the groove length l_{G} of the plurality of grooves is between 0.08 inch. and 0.8 inch suitable for a peripheral skirt height l^{A}ₛ of about 0.75 inch. In yet another aspect, the groove length l_{G} of the plurality of grooves is between 0.4 inch. and 0.8 inch suitable for a peripheral skirt height l^{A}ₛ of about 0.75 inch. In yet another aspect, the groove length l_{G} of the plurality of grooves is between 0.04 inch. and 0.4 inch suitable for a peripheral skirt height l^{A}ₛ of about 0.2 inch. In yet another aspect, the groove length l_{G} of the plurality of grooves is between 0.2 inch. and 0.4 inch suitable for a peripheral skirt height l^{A}ₛ of about 0.2 inch.

With reference to FIG. 10, a groove offset l_{G,O} of the plurality of grooves from the punch face may be controlled. If the groove offset l_{G,O} is too high, then it may be difficult to control the position of initiation of wrinkling. In an aspect, the groove offset l_{G,O} of the plurality of grooves from the punch face is between 0 and 1.5 inch for a peripheral skirt height l^{A}ₛ of about 0.2 inch to about 0.75 inch. In another aspect, the groove offset l_{G,O} of the plurality of grooves from the punch face is between 0 and 0.7 inch for a peripheral skirt height l^{A}ₛ of about 0.75 inch. In yet another aspect, the groove offset l_{G,O} of the plurality of grooves from the punch face is between 0 and 0.2 inch for a peripheral skirt height l^{A}ₛ of about 0.75 inch. In yet another aspect, the groove offset l_{G,O} of the plurality of grooves from the punch face is between 0 and 0.4 inch for a peripheral skirt height l^{A}ₛ of about 0.2 inch. In yet another aspect, the groove offset l_{G,O} of the plurality of grooves from the punch face is between 0 and 0.1 inch for a peripheral skirt height l^{a}ₛ of about 0.2 inch.

With reference to FIG. 7, a groove depth d_{G} of the plurality of grooves may be controlled. If the groove depth d_{G} is too low, then it may be difficult to initiate wrinkling within the grooves. If the groove depth d_{G} is too high, then the excess depth of the groove becomes unnecessary and may cause design constraint problems for the punch head. In an aspect, the groove depth d_{G} of the plurality of grooves is between 0.003 inch. and 0.24 inch. In another aspect, the groove depth d_{G} of the plurality of grooves is between 0.05 inch. and 0.22 inch. In yet another aspect, the groove depth d_{G} of the plurality of grooves is between 0.08 inch. and 0.20 inch. In yet another aspect, the groove depth d_{G} of the plurality of grooves is between 0.11 inch. and 0.18 inch. In an exemplary embodiment, the groove depth d_{G} of the plurality of grooves is about 0.16 inch.

With reference to FIG. 7, an edge radius ρc of the plurality of grooves may be controlled. If the edge radius ρc is too low, then movement of the paperboard into the grooves may be limited, and removal of the wrinkles from the groove may be hindered. If the edge radius ρc is too high, then control of the location of initiation and propagation of the wrinkles may be limited. In an aspect, the edge radius ρc of the plurality of grooves is between 0 and 0.32 inch. In another aspect, the edge radius ρc of the plurality of grooves is between 0.01 and 0.23 inch. In yet another aspect, the edge radius ρc of the plurality of grooves is between 0.02 and 0.19 inch. In yet another aspect, the edge radius ρc of the plurality of grooves is between 0.03 and 0.14 inch. In an exemplary embodiment, the edge radius ρc of the plurality of grooves is about 0.05 inch.

With reference to FIG. 7, a groove taper θ^{R}_{G,t} of the plurality of grooves with respect to the radial direction of the punch head may be controlled. If the groove taper θ^{R}_{G,t} is too high, then control of the location of initiation of wrinkling may be limited or insufficient wrinkling may occur. If the groove taper θ^{R}_{G,t} is too low, then initiation of wrinkling may be difficult. In an aspect, the groove taper θ^{R}_{G,t} of the plurality of grooves with respect to the radial direction of the punch head is between 0 and 30 degrees.

With reference to FIG. 7, the punch head 2 may include a rounded leading edge 5 defining the periphery of the punch face 3. The presence of the rounded leading edge can reduce cracking of a coating during a shaping process. In an aspect, an edge radius ρ_{E} of the rounded leading edge may be controlled. If the edge radius ρ_{E} of the rounded leading edge is too low, then the beneficial effect of the rounded leading edge on reducing cracking of a coating during a shaping process may be limited. If the edge radius ρ_{E} of the rounded leading edge is too high, then the excess edge radius ρ_{E} may not create an additional improvement in cracking and it may cause design constraint problems for the punch head. In an aspect, the edge radius ρ_{E} of the rounded leading edge is between 0.01 and 0.24 inch. In another aspect, the edge radius ρ_{E} of the rounded leading edge is between 0.05 and 0.22 inch. In yet another aspect, the edge radius ρ_{E} of the rounded leading edge is between 0.08 and 0.20 inch. In yet another aspect, the edge radius ρ_{E} of the rounded leading edge is between 0.12 and 0.18 inch. In an exemplary embodiment, the edge radius ρ_{E} of the rounded leading edge is about 0.16 inch.

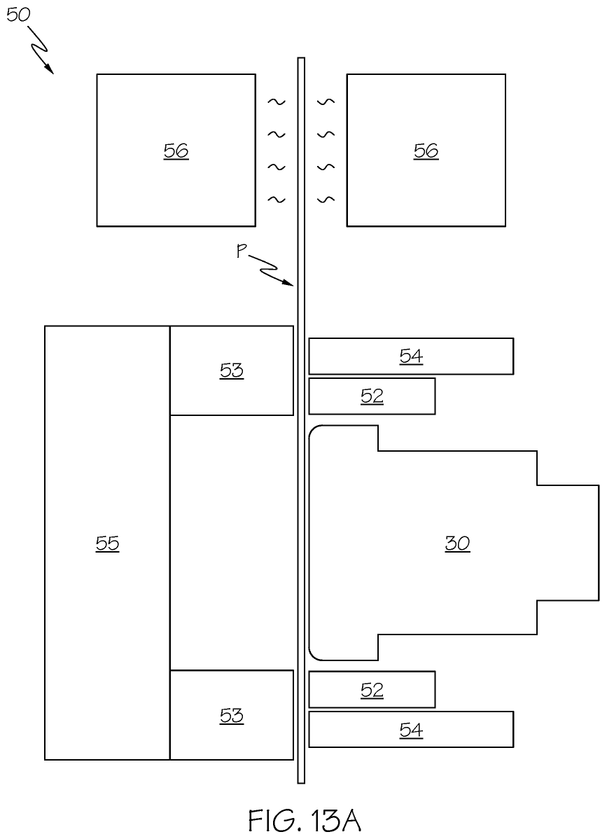

With reference to FIG. 8, a side surface height l^{A}ₛ in the axial direction of the punch head may be controlled. If the side surface height l^{A}ₛ in the axial direction of the punch head is too low, then it may be insufficient to shape a peripheral skirt. If the side surface height l^{A}ₛ in the axial direction of the punch head is too high, then the excess height of the peripheral skirt may not create an advantage and it may cause design constraint problems for the punch head. In an aspect, the side surface height l^{A}ₛ in the axial direction of the punch head is 0.1 to 2.0 inch. In another aspect, the side surface height l^{A}ₛ in the axial direction of the punch head is 0.3 to 0.5 inch. In yet another aspect, the side surface height l^{A}ₛ in the axial direction of the punch head is 0.6 to 1.0 inch.

With reference to FIG. 8, a punch face top diameter D_{P} may be controlled depending on a desired diameter of a resulting bottom wall of a paperboard bottom blank. In an aspect, a punch face top diameter D_{P} is between 1 and 8 inch. In another aspect, a punch face top diameter D_{P} is between 2 and 3 inch.

With reference to FIG. 8, a sidewall taper ratio of the punch face bottom diameter D_{P,b} to the punch face top diameter D_{P} may be controlled depending on a desired angle of a resulting peripheral skirt. In an aspect, the sidewall taper ratio is between 0.8 and 1.2.

It will be understood that the plurality of grooves may be preferably uniform such that each of the grooves along the side surface 4 about the entire periphery of the punch face 3 are the same. However, it will be understood that the plurality of grooves may vary from each other with respect to the above-defined parameters.

The punch head 2 of the present description may be used with a method for shaping a paperboard bottom blank. The method may include providing a paperboard bottom blank having a caliper thickness t and shaping the paperboard bottom blank using a cylindrical punch head, thereby shaping a bottom wall having a diameter D_{P} and a peripheral skirt having a skirt height lₛₖ about a periphery of the bottom wall of the paperboard bottom blank

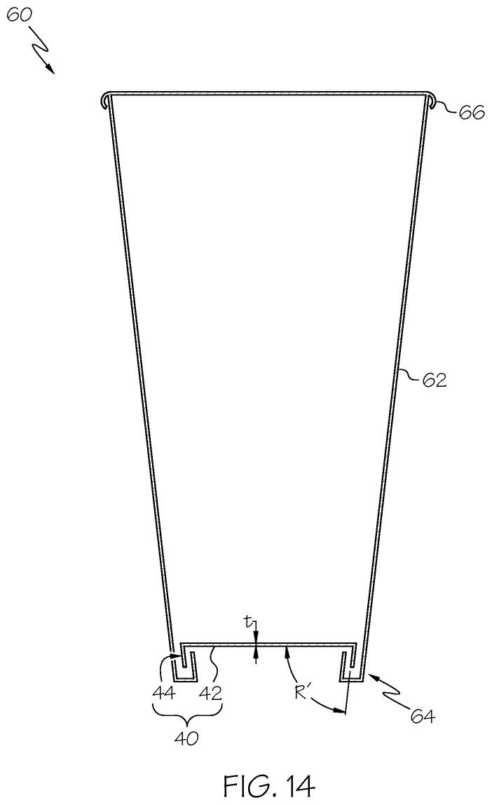

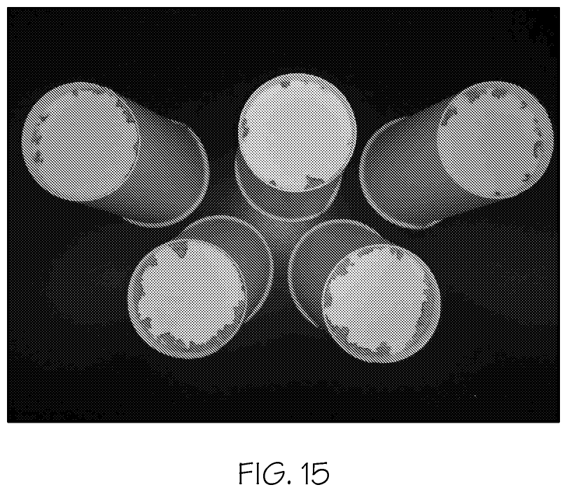

As shown in FIGS. 11 and 12, the paperboard bottom blank 20 may include a layered structure that includes a paperboard substrate 22 having a first major side and a second major side, a first barrier coating layer 24 applied to the first major side of the paperboard substrate 22 and a second barrier coating layer 26 applied to the second major side of the paperboard substrate 22. However, the layered structure of the coated paperboard bottom blank 20 is not limited to the illustrated embodiment. In any case, the caliper thickness t of the coated paperboard bottom blank is considered to include the entire thickness of the coated paperboard bottom blank from a first outermost surface to an opposing second outermost surface.

Referring to the embodiment illustrated in FIGS. 11 and 12, the first barrier coating layer 24 may define a first outermost surface of the coated paperboard bottom blank 20 and the second barrier coating layer 26 may define a second outermost surface of the coated paperboard bottom blank 20.

At this point, those skilled in the art will appreciate that various additional layers may be incorporated into the coated paperboard bottom blank 20 without departing from the scope of the present disclosure. In one variation, the coated paperboard bottom blank 20 may include a first basecoat between the paperboard substrate 22 and the first barrier coating layer 24, and the coated paperboard bottom blank 20 may include a second basecoat between the paperboard substrate 22 and the second barrier coating layer 26, or a third topcoat on top of the second barrier coating layer 26. In another variation, the coated paperboard bottom blank 20 may only include only a first barrier coating layer 24 on the paperboard substrate 22 without the second barrier coating layer 26.

The paperboard substrate 22 of the coated paperboard bottom blank 20 may be (or may include) any cellulosic material that is capable of being coated with the barrier coating layers. Those skilled in the art will appreciate that the paperboard substrate 22 may be bleached or unbleached. Examples of appropriate paperboard substrates include corrugating medium, linerboard, solid bleached sulfate (SBS), folding box board (FBB), and uncoated unbleached kraft (UUK).

The paperboard substrate 22 may have an uncoated basis weight of at least about 40 pounds per 3000 ft2. In one expression the paperboard substrate 22 may have an uncoated basis weight ranging from about 40 pounds per 3000 ft2 to about 300 pounds per 3000 ft2. In another expression the paperboard substrate 22 may have an uncoated basis weight ranging from about 85 pounds per 3000 ft2 to about 300 pounds per 3000 ft2. In another expression the paperboard substrate 22 may have an uncoated basis weight ranging from about 85 pounds per 3000 ft2 to about 250 pounds per 3000 ft2. In yet another expression the paperboard substrate 22 may have an uncoated basis weight ranging from about 100 pounds per 3000 ft2 to about 250 pounds per 3000 ft2.

Furthermore, the paperboard substrate 22 may have a caliper (thickness) ranging, for example, from about 4 points to about 30 points (0.004 inch to 0.030 inch). In one expression, the caliper range is from about 8 points to about 16 points. In another expression, the caliper range is from about 10 points to about 13 points.

The first barrier coating layer 24 and second barrier coating layer 26 may be applied using any suitable method, such as one or more coaters either on a paper machine or as off-machine coater(s) such that the first barrier coating layer 24 and second barrier coating layer 26 are formed on the exposed, outermost surfaces of the paperboard substrate 22. In an aspect, the first barrier coating layer 24 and the second barrier coating layer 26 may be heat-sealable barrier coating layers. When heated, a heat-seal coating provides an adhesion to other regions of a product (e.g. sidewall of a container) with which it contacts.

The first barrier coating layer 24 and second barrier coating layer 26 may be applied to the paperboard substrate 22 at various coat weights. As one, non-limiting example, the first barrier coating layer 24 and second barrier coating layer 26 may be applied at a coat weight of about 2 to 20 pounds per 3,000 square feet. As another, non-limiting example, the first barrier coating layer 24 and second barrier coating layer 26 may be applied at a coat weight of about 4 to 14 pounds per 3,000 square feet.

The first barrier coating layer 24 and second barrier coating layer 26 may include a binder and a pigment. In one expression, the ratio of the binder to the pigment can be at least about 1:2 by weight. In another expression, the ratio of the binder to the pigment can be about 1:2 to about 9:1 by weight. In another expression, the ratio of the binder to the pigment can be about 1:1 to about 4:1 by weight. In yet another expression, the ratio of the binder to the pigment can be at least about 1:1 by weight.

The binder may be an aqueous binder. As one general, non-limiting example, the binder may be styrene-acrylate (SA) (i.e., the binder “consists of” or “consists essentially of” styrene-acrylate (SA)). As another general, non-limiting example, the binder may be a mixture of binders that includes styrene-acrylate (SA). Other aqueous binders are also contemplated, such as styrene-butadiene rubber (SBR), ethylene acrylic acid (EAA), polyvinyl acrylic, polyvinyl acetate (PVAC), polyester dispersion, and combinations thereof.

In one variation, the pigment may be a clay pigment. As one example, the clay pigment may be kaolin clay, such as a fine kaolin clay. As another example, the clay pigment may be platy clay, such as a high aspect ratio platy clay (e.g., aspect ratio of at least 40:1). In another variation, the pigment may be a calcium carbonate (CaCO3) pigment. In yet another variation, the pigment may be a pigment blend that includes both calcium carbonate pigment and clay pigment.

FIGS. 6 to 10 are referenced, in combination with the parameters of Table 1 and with the following explanation, to express preferred parameters of the punch head 2 of the present description configured for use with the method for shaping a paperboard bottom blank having a caliper thickness t to shape a paperboard bottom blank having a diameter D_{P} and a peripheral skirt height l^{a}ₛ.

With reference to FIG. 9, a groove spacing θ^{R}_{G,s} between a centerline of adjacent grooves 6 of the plurality of grooves 6 may be controlled. If the groove spacing θ^{R}_{G,s} between a centerline of adjacent grooves 6 of the plurality of grooves 6 is too high, then it may be difficult to control a wrinkling between adjacent grooves 6. If the groove spacing θ^{R}_{G,s} between a centerline of adjacent grooves 6 of the plurality of grooves 6 is too low, then insufficient wrinkling within the grooves 6 may occur. In an aspect, the groove spacing θ^{R}_{G,s} between a centerline of adjacent grooves 6 of the plurality of grooves 6 is between 2 and 90 degrees. In another aspect, the groove spacing θ^{R}_{G,s} between a centerline of adjacent grooves 6 of the plurality of grooves 6 is between 6 and 65 degrees. In yet another aspect, the groove spacing θ^{R}_{G,s} between a centerline of adjacent grooves 6 of the plurality of grooves 6 is between 8 and 53 degrees. In yet another aspect, the groove spacing θ^{R}_{G,s} between a centerline of adjacent grooves 6 of the plurality of grooves 6 is between 11 and 40 degrees. In an exemplary embodiment, the groove spacing θ^{R}_{G,s} between a centerline of adjacent grooves 6 of the plurality of grooves is about 15 degrees.

With reference to FIGS. 2, 3, and 5, a number of grooves 6 along the side surface 4 about the entire periphery of the punch face 3 may be controlled. If the number of grooves along the side surface 4 about the entire periphery of the punch face 3 is too low, then it may be difficult to control a wrinkling between adjacent grooves 6. If the number of grooves along the side surface 4 about the entire periphery of the punch face 3 is too high, then insufficient initiation of wrinkling within the grooves may occur. In an aspect, the number of grooves 6 along the side surface 4 about the entire periphery of the punch face 3 is between 4 and 180. In another aspect, the number of grooves 6 along the side surface 4 about the entire periphery of the punch face 3 is between 10 and 128. In yet another aspect, the number of grooves 6 along the side surface 4 about the entire periphery of the punch face 3 is between 14 and 102. In yet another aspect, the number of grooves 6 along the side surface 4 about the entire periphery of the punch face 3 is between 17 and 76. In an exemplary embodiment, the number of grooves along the side surface 4 about the entire periphery of the punch face 3 is about 24.

With reference to FIG. 10, a groove taper θ^{A}_{G,t} of the plurality of grooves with respect to the axial direction of the punch head may be controlled. If the groove taper θ^{A}_{G,t} is too low (i.e. too negative), then then it may be difficult to control an initiation position of the wrinkles. If the groove taper θ^{A}_{G,t} is too high (i.e. too positive), then it may be difficult to control an propagation of the wrinkles. In an aspect, the groove taper θ^{A}_{G,t} of the plurality of grooves with respect to the axial direction of the punch head is between −30 and 30 degrees. In an exemplary embodiment, the groove taper θ^{A}_{G,t} of the plurality of grooves with respect to the axial direction of the punch head is approximately zero.

With reference to FIG. 7, a groove width w^{C}_{G}, at the punch face end, of the plurality of grooves may be controlled. If the groove width w^{C}_{G} is too low, then it may be difficult to initiate wrinkling within the grooves. If the groove width w^{C}_{G} is too high, then it may be difficult to control an initiation position of the wrinkles. In an aspect, the groove width w^{C}_{G} of the plurality of grooves is between 1 and 50 times the caliper thickness t of the paperboard bottom blank. In another aspect, the groove width w^{C}_{G} of the plurality of grooves is between 2 and 35 times the caliper thickness t of the paperboard bottom blank. In yet another aspect, the groove width w^{C}_{G} of the plurality of grooves is between 3 and 28 times the caliper thickness t of the paperboard bottom blank. In yet another aspect, the groove width w^{C}_{G} of the plurality of grooves is between 4 and 20 times the caliper thickness t of the paperboard bottom blank. In an exemplary embodiment, the groove width w^{C}_{G} of the plurality of grooves is about 6 times the caliper thickness t of the paperboard bottom blank.

With reference to FIG. 10, a groove length l_{G} of the plurality of grooves may be controlled. If the groove length l_{G} is too low, then it may be difficult to control initiation and propagation of wrinkling. If the groove length l_{G} is too high, then the excess height of the groove becomes unnecessary and may cause design constraint problems for the punch head. In an aspect, the groove length l_{G} of the plurality of grooves is between 0.1 and 1.0 times the skirt height lₛₖ of the peripheral skirt of the paperboard bottom blank. In another aspect, the groove length l_{G} of the plurality of grooves is between 0.3 and 0.9 times the skirt height lₛₖ of the peripheral skirt of the paperboard bottom blank. In yet another aspect, the groove length l_{G} of the plurality of grooves is between 0.6 and 0.8 times the skirt height lₛₖ of the peripheral skirt of the paperboard bottom blank.

With reference to FIG. 10, a groove offset l_{G,O} of the plurality of grooves from the punch face may be controlled. If the groove offset l_{G,O} is too high, then it may be difficult to control the position of initiation of wrinkling. In an aspect, the groove offset l_{G,O} of the plurality of grooves from the punch face is between 0 and 0.9 times the skirt height lₛₖ of the peripheral skirt of the paperboard bottom blank. In another aspect, the groove offset l_{G,O} of the plurality of grooves from the punch face is between 0 and 0.5 times the skirt height lₛₖ of the peripheral skirt of the paperboard bottom blank. In yet another aspect, the groove offset l_{G,O} of the plurality of grooves from the punch face is between 0 and 0.2 times the skirt height lₛₖ of the peripheral skirt of the paperboard bottom blank.

With reference to FIG. 7, a groove depth d_{G} of the plurality of grooves may be controlled. If the groove depth d_{G} is too low, then it may be difficult to initiate wrinkling within the grooves. If the groove depth d_{G} is too high, then the excess depth of the groove becomes unnecessary and may cause design constraint problems for the punch head. In an aspect, the groove depth d_{G} of the plurality of grooves is between 0.25 and 15 times the caliper thickness t of the paperboard bottom blank. In another aspect, the groove depth d_{G} of the plurality of grooves is between 1 and 10 times the caliper thickness t of the paperboard bottom blank.

With reference to FIG. 7, an edge radius ρc of the plurality of grooves may be controlled. If the edge radius ρc is too low, then movement of the paperboard into the grooves may be limited, and removal of the wrinkles from the groove may be hindered. If the edge radius ρ_{G} is too high, then control of the location of initiation and propagation of the wrinkles may be limited. In an aspect, the edge radius ρ_{G} of the plurality of grooves is between 0 and 20 times the caliper thickness t of the paperboard bottom blank. In another aspect, the edge radius ρ_{G} of the plurality of grooves is between 1 and 15 times the caliper thickness t of the paperboard bottom blank. In yet another aspect, the edge radius ρ_{G} of the plurality of grooves is between 2 and 10 times the caliper thickness t of the paperboard bottom blank.

With reference to FIG. 10, a groove taper OAc, of the plurality of grooves with respect to the axial direction of the punch head may be controlled. If the groove taper θ^{A}_{G,t} is too low (i.e. too negative), then then it may be difficult to control an initiation position of the wrinkles. If the groove taper θ^{A}_{G,t} is too high (i.e. too positive), then it may be difficult to control an propagation of the wrinkles. In an aspect, the groove taper θ^{A}_{G,t} of the plurality of grooves with respect to the axial direction of the punch head is between −30 and 30 degrees. In an exemplary embodiment, the groove taper θ^{A}_{G,t} of the plurality of grooves with respect to the axial direction of the punch head is approximately zero.

With reference to FIG. 7, the punch head 2 may include a rounded leading edge 5 defining the periphery of the punch face 3. The presence of the rounded leading edge can reduce cracking of a coating during a shaping process. In an aspect, an edge radius ρ_{E} of the rounded leading edge may be controlled. If the edge radius ρ_{E} of the rounded leading edge is too low, then the beneficial effect of the rounded leading edge on reducing cracking of a coating during a shaping process may be limited. If the edge radius ρ_{E} of the rounded leading edge is too high, then the excess edge radius ρ_{E} may not create an additional improvement in cracking and it may cause design constraint problems for the punch head. In an aspect, the edge radius ρ_{E} of the rounded leading edge is between 0 and 15 times the caliper thickness t of the paperboard bottom blank. In another aspect, the edge radius ρ_{E} of the rounded leading edge is between 1 and 13 times the caliper thickness t of the paperboard bottom blank. In yet another aspect, the edge radius ρ_{E} of the rounded leading edge is between 2 and 11 times the caliper thickness t of the paperboard bottom blank.

With reference to FIG. 8, a side surface height l^{A}ₛ in the axial direction of the punch head may be controlled. If the side surface height l^{A}ₛ in the axial direction of the punch head is too low, then it may be insufficient to shape a peripheral skirt. If the side surface height l^{A}ₛ in the axial direction of the punch head is too high, then the excess height of the peripheral skirt may not create an additional advantage and it may cause design constraint problems for the punch head. In an aspect, the side surface height l^{A}ₛ in the axial direction of the punch head is between 0.8 and 1.2 times the skirt height lₛₖ of the peripheral skirt of the paperboard bottom blank.

The method for shaping a paperboard bottom blank may further include heating the coated paperboard bottom blank. It has been discovered that cracking of a coating during a shaping process of a coated paperboard bottom blank can be reduced by heating the coated paperboard bottom blank before the shaping process. Although the invention is not limited by theory, it is believed that heating the coated paperboard bottom blank may increase a pliability of a barrier coating layer on a paperboard substrate and/or may increase a pliability of the paperboard substrate to relieve a stress transfer between the barrier coating layer and the paperboard substrate during a shaping process. For conventional polyethylene extrusion coated paperboard, heating of the polyethylene coating is typically unnecessary due to excellent flexibility of the polyethylene extrusion coating. Although it has been shown that cracking during a shaping process of an aqueous coated paperboard bottom blank has been reduced by pre-heating, it is projected that pre-heating can be effective for other coatings.

Additionally, the heating of the coated paperboard bottom blank may include applying moisture (e.g., steam) to the paperboard bottom blank before or during the step of shaping the paperboard bottom blank using the punch head 2 of the present description. It has been found that cracking during a shaping process has been even further reduced by applying moisture (e.g., steam) rather than just heat.

The application of moisture to the coated paperboard bottom blank is not limited by any particular process.

In one variation, the application of moisture to the coated paperboard bottom blank may include applying steam to the coated paperboard bottom blank using a non-contact heating, such as a hot moist air blower.

In another variation, the application of moisture to the coated paperboard bottom blank may include contacting the coated paperboard bottom blank with a water and then a heated die during a process for shaping the heated coated paperboard bottom blank.

In an aspect, the method may omit the step of applying moisture to the coated paperboard bottom blank.

A preferred method includes applying steam to the coated paperboard bottom blank and shaping the resulting paperboard bottom blank using a punch head having a leading-edge radius and a plurality of grooves in a side surface of the punch head. It has been discovered that the combined effect of applying steam with a leading-edge radius and the plurality of grooves considerably minimizes cracking of a coating during the shaping process. However, in a variation, the application of steam may be employed with a conventional leading-edge radius of a punch head and plurality of grooves in a side surface of the punch head. In another variation, the punch head having the plurality of grooves may be employed with or without heating, application of steam or a leading-edge radius.

In an aspect, the method may be performed by a cup bottom forming apparatus. The cup bottom forming apparatus includes a punching assembly for shaping the coated paperboard bottom blank to form a peripheral skirt portion about a periphery of a bottom wall portion of the coated paperboard bottom blank and an optional heater positioned to heat the coated paperboard bottom blank prior to and/or during formation of the peripheral skirt portion. The optional heater may optionally apply moisture.

In an aspect, the heater includes a non-contact heater positioned to heat the coated paperboard prior to the punching of the coated paperboard bottom blank.

In another aspect, the heater includes a contact heater positioned to heat a die contacting the coated paperboard within the punching assembly.

The cup bottom forming apparatus may further include a cutting assembly for cutting the coated paperboard bottom blank from a web of coated paperboard.

In an aspect, the heater includes a non-contact heater positioned to heat the coated paperboard prior to the cutting of the coated paperboard bottom blank.

In an aspect, the heater includes a contact heater positioned to heat a die contacting the coated paperboard within the cutting assembly.

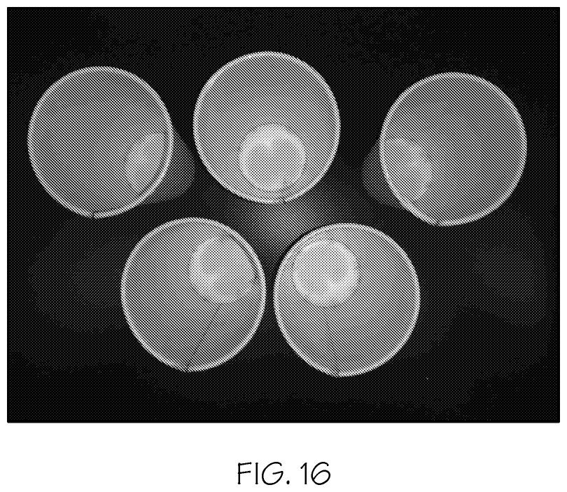

FIGS. 13A, 13B and C are schematic views of an exemplary cup bottom forming apparatus 50 for shaping a coated paperboard bottom blank cut from a roll of paper that feeds a strip of paper vertically downward in the illustrated figures. As shown, the cup bottom forming apparatus includes a punch 30 around which the peripheral skirt is formed as the punch draws the cut-out blank through the main die 53. In an aspect, the cup bottom forming apparatus 50 may further includes cutters 52 for cutting the coated paperboard into a coated paperboard bottom blank, and casing 54. The punch 30 and cutters 52 may be attached to a piston (not shown) to perform their respective functions. The punch 30 may include one or more features of the punch 1 as described above.

In an aspect, the cup bottom forming apparatus 50 may further include a contact heater 55 for heating a die during a process for shaping the heated coated paperboard bottom blank P. It should be understood that the placement of the contact heater is merely illustrative and that any of the dies or tools in the cup bottom forming apparatus 50, including punch 30, contacting the coated paperboard bottom blank P may be heated to affect the heating of the coated paperboard bottom blank P.

In an aspect, the cup bottom forming apparatus 50 may further include non-contact heaters 56 for heating the coated paperboard P. In an example, the non-contact heaters 56 may include a hot air blower blowing heated air to the frontside and/or backside of the coated paperboard P. In another example, the non-contact heaters 56 may include an infrared heater for heating the frontside and/or backside of the coated paperboard P. In another example, the non-contact heaters 56 may include steam applicator (moisture and heat).

In an aspect, the cup bottom forming apparatus 50 may further include contact heaters 56 for heating a die in contact with the coated paperboard P. In an example, the contact heaters 56 may include heating tape held onto the respective dies with heat-reflective metallic tape.

However, it should be understood that the cup bottom forming apparatus of FIGS. 13A, 13B and 13C is merely a representation of one exemplary cup bottom forming apparatus for practicing the invention.

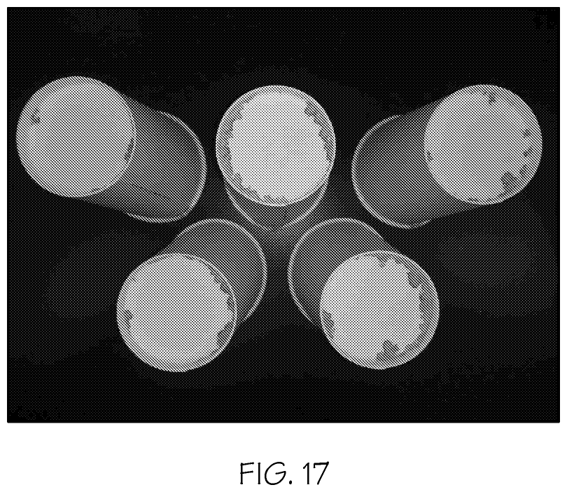

FIG. 14 is a sectional schematic view of a representation of a coated paperboard container according to an embodiment of the present invention.

As shown in FIG. 14, the coated paperboard container 60 includes a coated paperboard bottom 40 having a caliper thickness t and a coated paperboard sidewall 62. The coated paperboard bottom 40 includes a paperboard substrate and a first barrier coating layer on an outermost surface of the paperboard substrate (see FIGS. 11 and 12) and the coated paperboard bottom 40 includes peripheral skirt portion 44 formed about a periphery of a bottom wall portion 42, wherein a radius R′ defining between the peripheral skirt portion 44 and the bottom wall portion 42 is greater than 3t. The coated paperboard sidewall 62 is sealed to the first barrier coating layer of the peripheral skirt portion 44.

In an aspect, the radius R′ corresponds to a leading edge radius R of a punch used to shape the peripheral skirt portion 44 and the bottom wall portion 42 from a coated paperboard bottom blank.

In an aspect, the paperboard bottom further includes a second barrier coating layer on another outermost surface of the paperboard substrate, and the coated paperboard sidewall may be sealed to the second barrier coating layer of the peripheral skirt portion. For example, as illustrated, a bottom portion of the paperboard sidewall may be folded over the peripheral skirt and bonded (e.g. heat-sealed) to both sides of the peripheral skirt.

In an aspect, the interior surface of the coated paperboard sidewall may include a barrier coating at an outermost surface thereof. For example, the barrier coating may the same as one or both of the barrier coatings on the paperboard bottom. In an aspect, the barrier coating may comprise an aqueous binder, such as styrene-acrylate.

### EXAMPLES

Coated paperboard samples, specifically used to make the cups in the following examples, include 13pt (1pt=0.001″) and 16pt solid bleached sulfate (SBS) cupstock substrate manufactured by WestRock Company of Atlanta, Ga., and then coated with a heat-sealable barrier coating on a pilot blade coater. The heat-sealable barrier coating formulation contained HYDROCARB® 60 (Omya AG of Oftringen), BARRISURF™ XP (IMERYS Kaolin), and CARTASEAL® SCR (Archroma) at a ratio of 65/35/250 by weight. The 13pt cupstock coated with two layers of the barrier coating on the felt side at a total coat weight of 9.3 lb/3000F2 was used as bottom stock for the cup containers, and the 16pt cupstock coated with two layers of the barrier coating on the felt side at a total coat weight of 10.3 lb/3000F2 was used as side wall for the cup containers. The coated barrier side was facing inside of the cup for both the cup bottom and the side wall.

The cups were made on a PMC (Paper Machinery Corporation) cup machine, model PMC-1250.

### Example 1

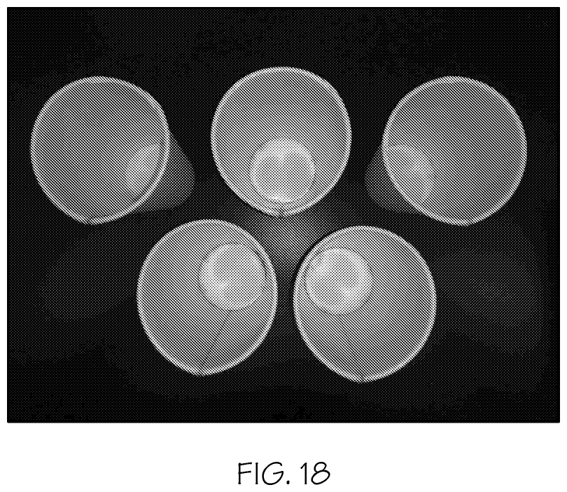

The cups of FIGS. 15 and 16 were formed using a punch head substantially as shown in FIGS. 2 to 5, except without grooves, to shape heated paperboard bottom blanks, which were then heat sealed to sidewalls.

### Example 2

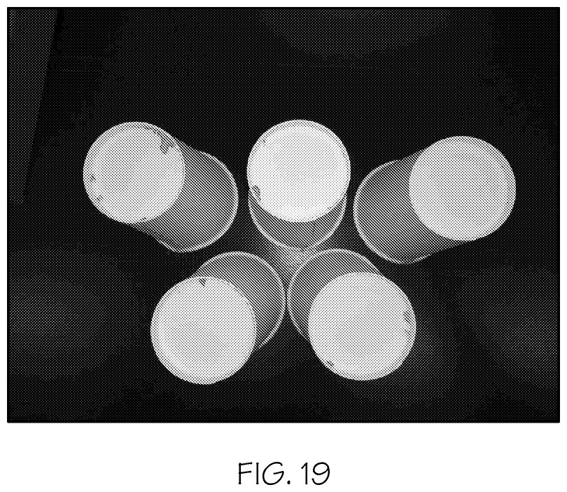

The cups of FIGS. 17 and 18 were formed using a punch head substantially as shown in FIGS. 2 to 5, with grooves, to shape heated paperboard bottom blanks, which were then heat sealed to sidewalls.

### Example 3

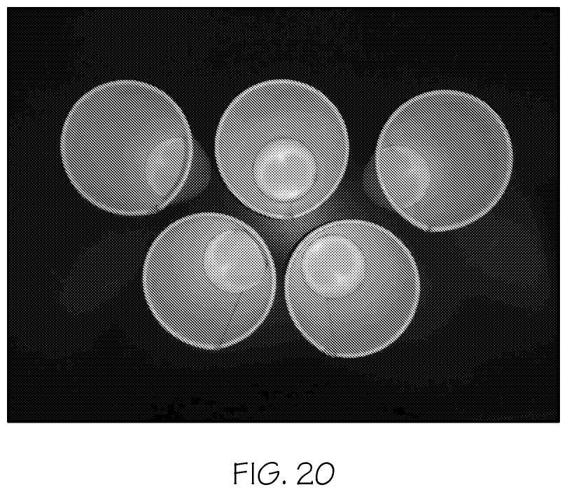

The cups of FIGS. 19 and 20 were formed using a punch head substantially as shown in FIGS. 2 to 5, with grooves, to shape heated paperboard bottom blanks with additional treatment by steam, which were then heat sealed to sidewalls.

Results

FIGS. 15 to 20 show the penetration of a hot coffee and non-dairy creamer mixture into the cup bottoms after 30 minutes (viewed from above and below after the coffee has been drained and rinsed out) for the proposed solutions. The coffee staining in the pictures of FIGS. 15 to 20 relate to a worst-case condition (very hot coffee with a particularly aggressive non-dairy creamer). These cups typically would not show staining for other less aggressive liquids such as standard coffee, Coca-Cola®, etc.

As shown in FIGS. 15 to 16, the cups of Example 1 showed substantial staining about the periphery of the bottom rim. As shown in FIGS. 17 to 18, the cups of Example 2 showed decreased staining compared to the cups of Example 1. As shown in FIGS. 19 to 20, the cups of Example 3 showed decreased staining compared to the cups of Example 2.

Although various embodiments of the disclosed methods and coated paperboard containers have been shown and described, modifications may occur to those skilled in the art upon reading the specification. The present application includes such modifications and is limited only by the scope of the claims.

1. A cylindrical punch head for shaping a paperboard bottom blank to shape a peripheral skirt portion about a periphery of the paperboard bottom blank, the cylindrical punch head comprising:
a punch face extending in a radial direction about an axis of the punch head; and
a side surface extending in an axial direction of the punch head about a periphery of the punch face, wherein the side surface defines a plurality of grooves, each groove extending in the axial direction of the punch head.

2. The cylindrical punch head of claim 1, wherein groove spacing between a centerline of adjacent grooves of the plurality of grooves is between 2 and 90 degrees.

3. The cylindrical punch head of claim 1, wherein groove spacing between a centerline of adjacent grooves of the plurality of grooves is between 6 and 65 degrees.

4-6. (canceled)

7. The cylindrical punch head of claim 1, wherein the number of grooves is between 4 and 180.

8. The cylindrical punch head of claim 1, wherein the number of grooves is between 10 and 128.

9-11. (canceled)

12. The cylindrical punch head of claim 1, wherein a groove taper of the plurality of grooves with respect to the axial direction of the punch head is between −30 and 30 degrees.

13. The cylindrical punch head of claim 1, wherein a groove width of the plurality of grooves is between 0.01 inch. and 0.8 inch.

14. The cylindrical punch head of claim 1, wherein a groove width of the plurality of grooves is between 0.03 inch. and 0.6 inch.

15-17. (canceled)

18. The cylindrical punch head of claim 1, wherein a groove length of the plurality of grooves is between 0.02 inch. and 2 inch.

19. The cylindrical punch head of claim 1, wherein a groove length of the plurality of grooves is between 0.08 inch. and 0.8 inch.

20-22. (canceled)

23. The cylindrical punch head of claim 1, wherein a groove offset of the plurality of grooves from the punch face is between 0 and 1.5 inch.

24. The cylindrical punch head of claim 1, wherein a groove offset of the plurality of grooves from the punch face is between 0 and 0.7 inch.

25-27. (canceled)

28. The cylindrical punch head of claim 1, wherein a groove depth of the plurality of grooves is between 0.003 inch. and 0.24 inch.

29-32. (canceled)

33. The cylindrical punch head of claim 1, wherein an edge radius of the plurality of grooves is between 0 and 0.32 inch.

34-37. (canceled)

38. The cylindrical punch head of claim 1, wherein a groove taper of the plurality of grooves with respect to the radial direction of the punch head is between 0 and 30 degrees.

39. The cylindrical punch head of claim 1, further comprising a rounded leading edge defining the periphery of the punch face.

40. The cylindrical punch head of claim 39, wherein an edge radius of the rounded leading edge is between 0.01 and 0.24 inch.

41-44. (canceled)

45. The cylindrical punch head of claim 1, wherein a side surface height in the axial direction of the punch head is 0.1 to 2.0 inch.

46-47. (canceled)

48. The cylindrical punch head of claim 1, wherein a punch face top diameter is between 1 and 8 inch.

49. (canceled)

50. A method for shaping a paperboard bottom blank, the method comprising:
providing a paperboard bottom blank having a caliper thickness t;
shaping the paperboard bottom blank using a cylindrical punch head, thereby shaping a bottom wall having a diameter D_{P} and a peripheral skirt having a skirt height lₛₖ about a periphery of the bottom wall of the paperboard bottom blank, the cylindrical punch head comprising:
a punch face extending in a radial direction about an axis of the punch head; and
a side surface extending in an axial direction of the punch head about a periphery of the punch face, wherein the side surface defines a plurality of grooves, each groove extending in the axial direction of the punch head.

51-88. (canceled)
